(19) United States
(12) Patent Application Publication
(10) Pub. No.: US 2009/0158004 A1
(43) Pub. Date: Jun. 18, 2009

(54) TLB Virtualization Method of Machine Virtualization Device, and Machine Virtualization Program

(76) Inventors: Tomohide Hasegawa, Zama (JP); Makiko Shinohara, Hadano (JP); Norimitsu Hayakawa, Inagi (JP); Souichi Takashige, Hachiouji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/323,618

(22) Filed: Nov. 26, 2008

(30) Foreign Application Priority Data
Dec. 18, 2007 (JP) 2007-325802

(51) Int. Cl. G06F 12/10; G06F 12/00; G06F 9/455

(52) U.S. Cl. 711/207; 718/1; 711/E12.001; 711/E12.061

(57) ABSTRACT

A TLB virtualization method of a machine virtualization device which, in the case where a TLB is shadowed in a virtualization environment, avoids TLB entry conflicts and is capable of improving the performance of a virtualization environment; wherein a hypervisor is executed on a real machine, an OS is operated on a plurality of virtual machines generated by means of processing based on the hypervisor, TLB entry calculations are carried out using RID values in the virtual machines by means of hypervisor processing, the RID values in the virtual machines used in the TLB entry calculations in the real machine are translated into different values in said plurality of virtual machines, and, further, the values of the bit strings of translated RID values are modified.

### INCORPORATION BY REFERENCE

The present application claims priority from Japanese application JP 2007-325802 filed on Dec. 18, 2007, the content of which is hereby incorporated by reference into this application.

### BACKGROUND OF THE INVENTION

The present invention pertains to the TLB virtualization technology of a machine virtualization device and pertains, in particular, to technology that is valid for application to the avoidance of conflicts in TLB entries occurring in the same virtualization.

In recent years, computer technology simultaneously operating a plurality of virtual machines in computers based on PC architecture has come into the spotlight and merits such as a reduction in the number of computers carrying real operations and simplifications in the operation and configuration changes due to hardware concealment are in the process of permeating into the market.

Machine virtualization is implemented by means of cooperation between hardware and software, but technologies for implementing virtual machines with high performance and high functionality are developed respectively.

One essential function provided in computers is that of address translation. Address translation is an indispensable computer function in case there is assumed a current operating system (hereinafter called “OS”) provided with a multitasking function.

The expression “address translation” refers to the fact of translating an address (a virtual address) in the virtual address space operated by a program into an address (a physical address) in the memory space of a computer and, with address translation based on the paging scheme which is adopted in most of the current computer architectures, there is carried out a translation of the higher-order bits of a virtual address determined by the page size into a value corresponding to the physical address.

Address translation processing needs to be executed with high speed as it is concerned with all memory access operations and processing is carried out in hardware by means of a buffer memory, called TLB (Translation Lookaside Buffer), storing address translation couples of virtual addresses and physical addresses.

Since a virtual address space is allocated for each process, virtual addresses for different processes must be translated into separate physical addresses. In order for the hardware to distinguish these (particularly within one TLB), there are address space identifiers (such as ASID (Address Space Identifier) and RID (Region Identifier)) which are provided in hardware (hereinafter called “RID”).

In this case, address translation refers to translating the virtual address of the virtual address space shown in the value of the RID register (RID) into a physical address and storing, in the TLB, couples of address translation from the RID and the virtual address to the physical address.

Machine virtualization refers to the fact of implementing a plurality of virtual machines on one piece of hardware, there being a need for each of the respective virtual machines to indicate independent physical memory spaces and there also being a need to support independent address translation functions in each of the respective virtual machines.

In order to implement this with a memory of which there is physically only one, there is a need for the physical addresses of the respective virtual machines to be translated once again in order that they do not respectively conflict. Stated specifically, it comes about that the virtual address of the virtual address space indicated with the RID of a certain virtual machine is translated into the physical address of the virtual machine, and the same is once again translated into the physical address of the real machine.

In order to carry out this double address translation at high speed, there is the method in which software for implementing a high-performance virtual machine environment (hereinafter, this software is called “hypervisor”) administers the address translation so as to store in the TLB a virtual machine virtual address to real machine physical address translation couple.

If this method is used, as long as there is an address translation couple in the TLB, there can, as for the processing corresponding to each memory access, be expected processing at a real time which is the same as the non-virtualized time. This method is called TLB shadowing. In the case of carrying out TLB shadowing, the following translations are carried out in case the hypervisor registers the address translation couple in the TLB.

1. The physical address of each virtual machine is translated into a physical address of a real machine.

2. The RID values of each virtual machine are converted so that there are no conflicts between the respective virtual machines.

More often than not, there is, as the performed method, carried out one in which the VMID (Virtual Machine Identifier) is entered into one part of the RID.

Considering address translation function methods mentioned this far and occurring in machine virtualization, these are described in works such as James E. Smith, Ravi Nain, and Ravi Nair: “Virtual Machines: Versatile Platforms For Systems and Processes”, Morgan Kaufmann Series in Computer Architecture and Design, June 2005, pp. 396-404; and ISSN 1535-864X, Intel Virtualization Technology, Vol. 10, Issue 03.

### SUMMARY OF THE INVENTION

Since the number of TLB entries (i.e., the number of address translation couples that can be stored) is limited, it is important from the viewpoint of performance to use the same effectively.

In the address translation function occurring in prior art machine virtualization, TLB entry conflicts ended up getting generated, the result being a cause of performance reduction.

In a virtualization environment, since the address translation couples of each virtual machine are stored in one TLB, the number of TLB entries per virtual machine becomes relatively small, so if one considers that the influence of a case where a TLB miss occurs is great (in a non-virtualization environment, the OS processing in the case of a TLB miss becomes overhead but in a virtualization environment, overhead of the hypervisor is also added), and the like, there are also situations in which it must be regarded as even more important in the case of a virtualization environment.

Accordingly, it is an object of the present invention to avoid TLB entry conflicts and to furnish a TLB virtualization method and machine virtualization program of a machine virtualization device capable of improving the performance of a virtualization environment, in the case where the TLB is shadowed in a virtualization environment.

The aforementioned and other objects and novel characteristics of the present invention should become clear from the description and accompanying drawings of the present specification.

Among the inventions disclosed in the present application, a brief description of the outline of a representative aspect thereof would be as follows.

Specifically, as for the outline of the representative aspect, the RID value in the virtual machine used in the calculation of a TLB entry in the real machine is translated into different values in a plurality of virtual machines by means of hypervisor processing and further, the values of the bit strings of the translated RID values are modified.

Among the inventions disclosed in the present invention, a brief description of the effects to be obtained by means of the representative aspect would be as follows.

Specifically, the effects to be obtained by means of the representative aspect are, in case a TLB is shadowed in a virtualization environment, to avoid TLB entry conflicts and improve the performance of the virtualization environment.

The present invention pertains to the TLB virtualization method of a machine virtualization device and can be widely applied to devices using address translation in machine virtualization.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory diagram for describing address translation for the TLB virtualization method of a machine virtualization device of the present invention.

FIG. 2 is an explanatory diagram for describing TLB conflicts in the prior art for the TLB virtualization method of a machine virtualization device of the present invention.

FIG. 3 is an explanatory diagram for describing TLB entry conflict avoidance in the TLB virtualization method of a machine virtualization device of the present invention.

FIGS. 4A and 4B are explanatory diagrams for explaining the principles of TLB entry conflict avoidance in the TLB virtualization method of a machine virtualization device of the present invention.

FIG. 5 is an explanatory diagram for explaining hypervisor processing occurring in a TLB virtualization method of a machine virtualization device related to Embodiment 1 of the present invention.

FIG. 6 is an explanatory diagram for explaining processing by which translation is carried out using a lookup table occurring in the TLB virtualization method of a machine virtualization device related to Embodiment 1 of the present invention.

FIGS. 7A and 7B are explanatory diagrams for describing the principles of hypervisor processing occurring in the TLB virtualization method of a machine virtualization device related to Embodiment 2 of the present invention.

FIG. 8 is an explanatory diagram for describing hypervisor processing occurring in the TLB virtualization method of a machine virtualization device related to Embodiment 2 of the present invention.

### DESCRIPTION OF THE EMBODIMENTS

Hereinafter, the embodiments of the present invention will be described in detail on the basis of the drawings. Further, in all the diagrams for describing the embodiments, like reference numerals are in principle used to designate like parts, a description thereof being omitted.

First, a description will be given regarding the object of application of the present invention.

The present invention targets computers having an architecture with which it is possible to distinguish a plurality of virtual address spaces by means of RIDs and register the same in the TLB. Also, regarding the virtualization thereof, the invention targets computers that also have a method in which a hypervisor carries out shadowing of the TLB and, regarding the RIDs, modifies the same so as to take on unique values in all the virtual machines in order to distinguish the virtual address space of each virtual machine inside the TLB.

In this case, an RID setting instruction due to a guest OS is trapped and control is transferred to the hypervisor and, in order that same RID values cannot be obtained in each of the virtual machines, the values are modified to shadow RID values and set in a hardware register holding RIDs. This is something that, concerning the determination of the shadow RID value, is possible for the hypervisor to determine, the present invention avoiding TLB entry conflicts and improving the performance of the virtualization environment by means of utilizing this manipulation, specific to the virtualization environment of the present invention.

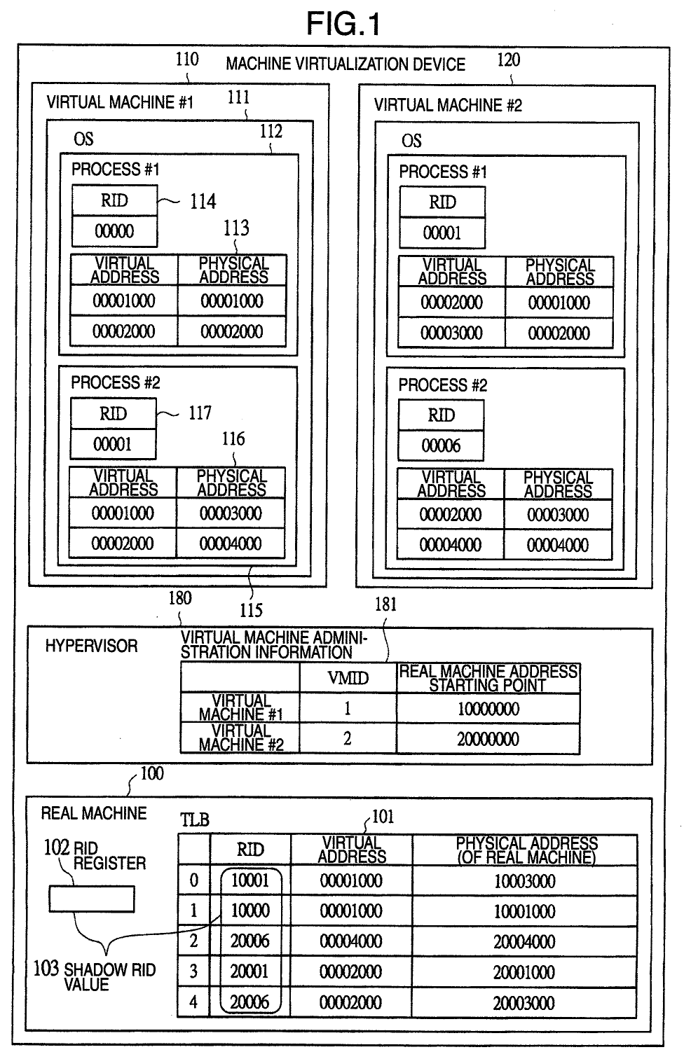

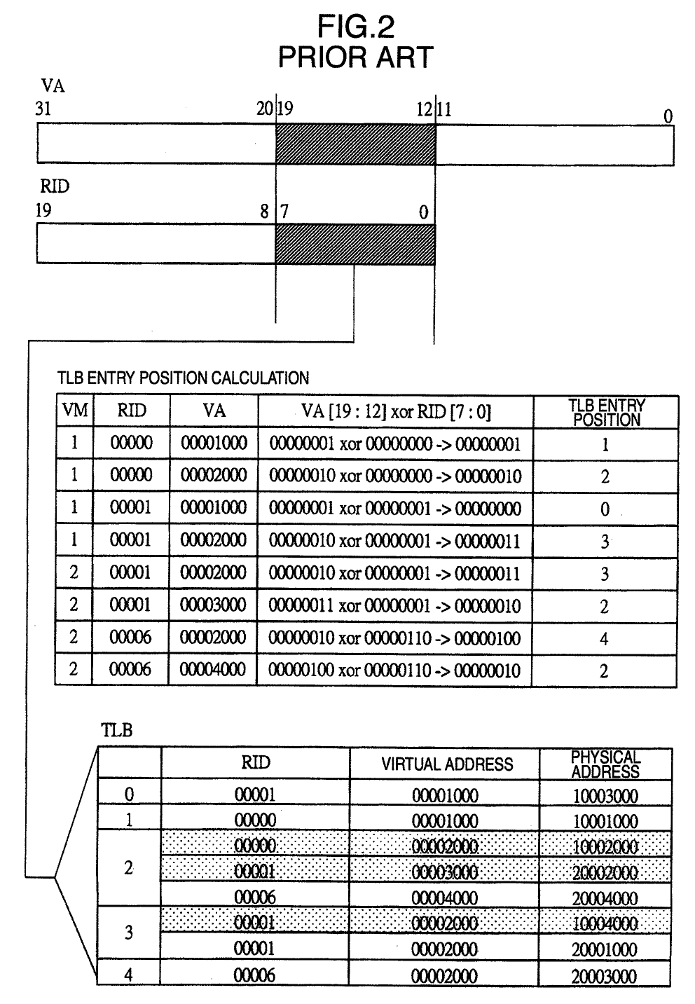

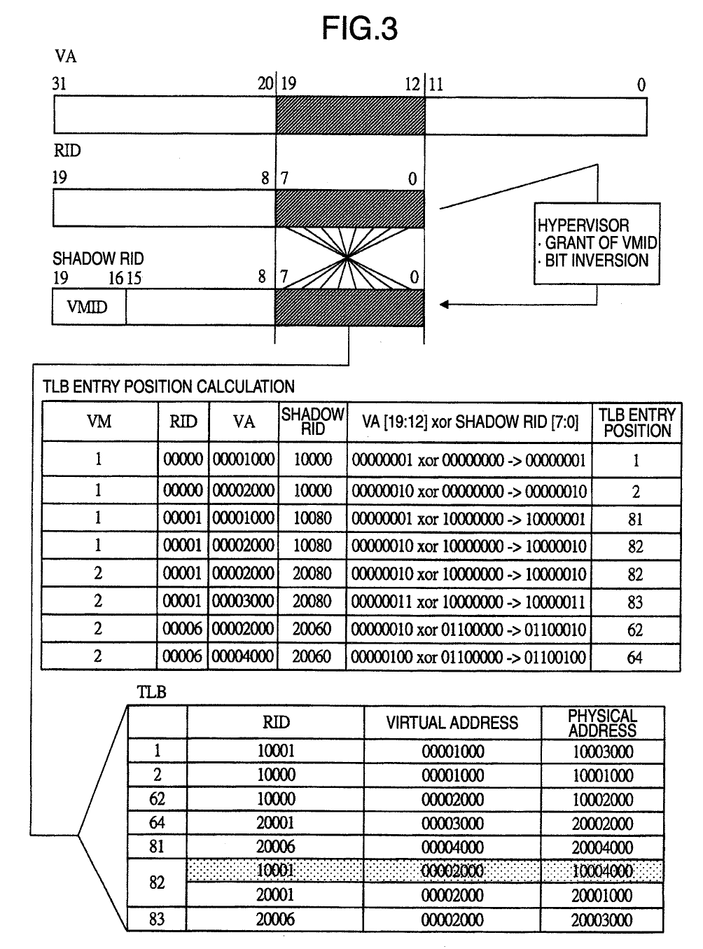

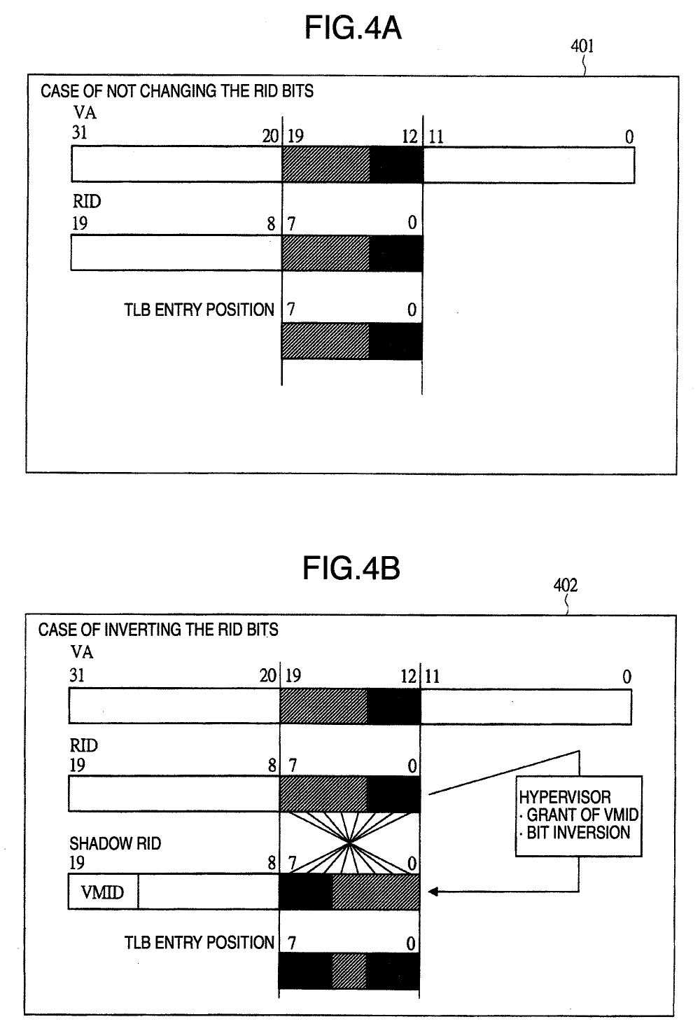

Next, before describing the embodiments of the present invention, a description will be given, by means of FIG. 1 to FIG. 4B, regarding prior art and an outline of the TLB virtualization method of a machine virtualization device of the present invention. FIG. 1 to FIG. 4B are explanatory diagrams for given explanations and an outline of the TLB virtualization method, FIG. 1 being an explanatory diagram for describing address translation, FIG. 2 being an explanatory diagram for describing TLB entry conflicts in the prior art, FIG. 3 being an explanatory diagram for describing TLB entry conflict avoidance, and FIGS. 4A and 4B being explanatory diagrams for describing the principles of TLB entry conflict avoidance.

In FIG. 1, a virtual machine #1 110 and a virtual machine #2 120 are virtual machines generated by means of a hypervisor 180 operating on a real machine 100. On the basis of the administration of an OS (operating system) 111 on virtual machine #1 110, a plurality of processes 112, 115 run in independent virtual address spaces. Virtual machine #2 120 is like virtual machine #1 110.

OS 111 prepares address translation tables 113, 116 with respect to the respective processes and administers virtual address spaces and physical address spaces of virtual machines for each process. It sets respective RIDs 114, 117 with respect to the address spaces.

Hypervisor 180 possesses virtual machine administrative information 181 and administers, for each virtual machine, VMIDs and memory locations in the real machine of the virtual machine physical address spaces.

The values set in TLB 101 present in real machine 100 are shadowed by means of the hypervisor so as to become address translation couples from virtual machines virtual addresses to real machine physical addresses. By means of TLB shadowing, a virtual address of a virtual machine is immediately translated to a physical address of the real machine, in case there is an address translation couple inside the TLB.

As for the value set in RID register 102, the hypervisor modifies it so as to add a VMID to a portion of the RIDs in order that the virtual address spaces of all the virtual machines become unique inside the TLB. This is called RID shadowing.

Two virtual machines have identical virtual address spaces with the RID being 00001, but this is shadowed by means of the hypervisor so as to add a VMID at the beginning of the RIDs and the RIDs are respectively distinguished as 10001 and 20001 within the TLBs. These translated RID values are called shadow RID values 103.

In FIG. 2, virtual addresses (hereinafter sometimes also expressed as “VA”) are taken to be 32 bits and RIDs are taken to be 20 bits (a notation [n:m] is used in order to express the portion from the nth bit to the mth bit of address values and the like).

The address translation page size is taken to be 4096 bytes, in which case VA[31:12] become the translation target bits of the address translation. The number of TLB entries is taken to be 256 entries, the consulted entry position in the address translation taken to be the eight bits value (the TLB entry address) obtained by an exclusive OR operation on the eight bits VA[19:12] and the eight bits RID[7:0].

If one calculates the TLB entry position corresponding to eight sets of RIDs and virtual addresses present within FIG. 1, the result is that three translations correspond to entry #2 and two translations correspond to entry #3. This is called a TLB entry conflict but, in this case, the result is that the address translation couple coming in first is overwritten and gets erased from the TLB, resulting in a reduction in performance.

In FIG. 3, the VMID is taken to be four bits and in the shadowing of the RID, the RID[19:16] portion is added to the VMID. At this point, there is added the manipulation of inverting the bits used in the TLB operation of the RID. Similarly, when the TLB entry position is calculated, it is identified that TLB entry conflicts are reduced.

Next, in the foregoing, there was shown an example in which, by inverting the bits in the RID shadowing, TLB conflicts are reduced, and according to FIG. 4, it is explained that this method is effective generally.

In cases such as where the RIDs are used in ascending order, even though RID[0] changes often, it turns out that the higher-order bits of the RID do not change much. Moreover, in cases such as where a virtual address is also used on a contiguous page, VA[12] changes often, but it turns out that the higher-order bits indeed do not change.

In FIGS. 4A and 4B, there are shown cases in which this property has been considered in the calculation of a TLB entry position, the case where the RID bits do not change (401) being shown in FIG. 4A and the case where the RID bits are inverted (402) being shown in FIG. 4B. In FIGS. 4A and 4B, RID bits which change often are painted over in black.

Here, if one observes the case in which the RID bits do not change, bits that change often are in the same positions in the calculation of the exclusive OR, and as for the TLB entry positions in the operation, it is distinguished that bits that change often are difficult to reflect in the TLB entry positions.

Moreover, in case the RID bits are inverted, it is distinguished that the bits that change often are reflected in the TLB entry positions.

In Embodiment 1 below, an explanation will be given regarding an example in which, in case it is distinguished that there are virtual address and RID bits with big changes, the RID bit positions are modified in a fixed way in the hypervisor, those portions, by bit in the TLB entry positions, having a great number of changes being increased and the TLB being utilized with high efficiency, as shown here, and in Embodiment 2, an explanation will be given regarding an example in which optimal bit shift operations are carried out automatically by observing the number of changes by virtual address and RID bit, so that this has an effect even in a variety of situations.

### 1. First Embodiment

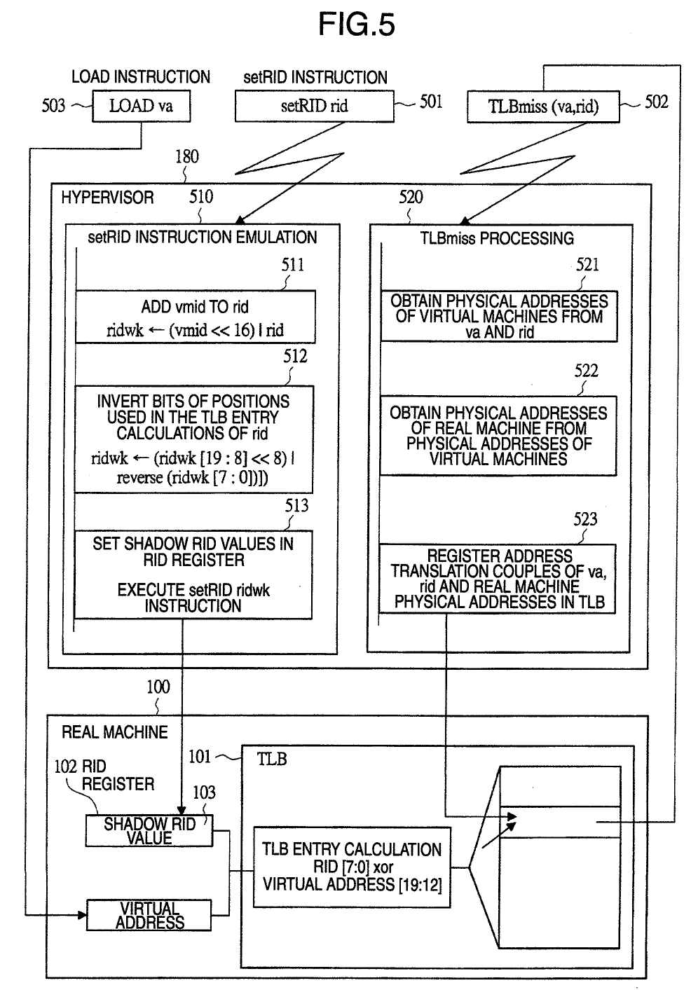

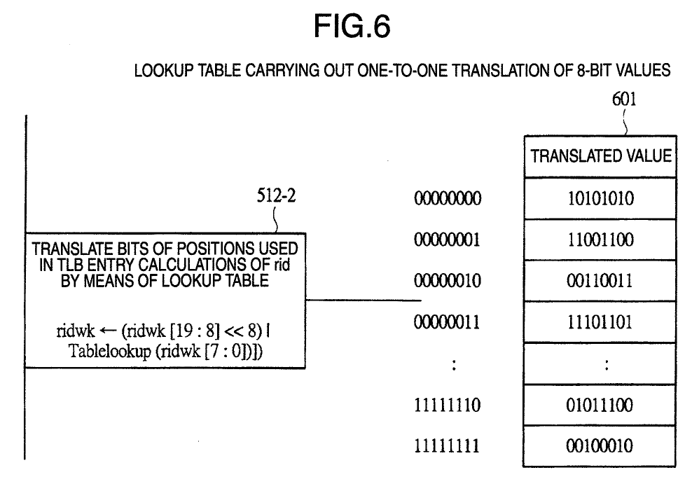

By means of FIG. 5 and FIG. 6, there will be given an explanation regarding hypervisor processing occurring in the TLB virtualization method of a machine virtualization device related to Embodiment 1 of the present invention. FIG. 5 is an explanatory diagram for describing hypervisor processing occurring in the TLB virtualization method of a machine virtualization device related to Embodiment 1 of the present invention and FIG. 6 is an explanatory diagram for describing processing carried out using a lookup table in the TLB virtualization method of a machine virtualization device related to Embodiment 1 of the present invention.

In FIG. 5, hypervisor 180 is software operating on a real machine 100 and holds processing activated by interrupts in real machine 100.

The setRID instruction 501 is an instruction setting a value designated with an operand in RID register 102.

Also, TLBmiss message 502 is an interrupt generated when there is no address translation couple included within TLB 101 and address translation is not possible and is reported together with information about virtual addresses and RID information that could not be translated.

A LOAD instruction 503 is an instruction to read virtual address data designated in the operand and the used virtual address space is a space indicating the RID values set in RID register 102 at that time.

In order to access the memory in real machine 100, address translation is conducted by means of the TLB.

The TLB entry indicated by the TLB entry address obtained by performing an exclusive OR operation on RID[7:0] and virtual address [19:12] is consulted and if there is an address translation couple corresponding thereto, the physical address of the corresponding real machine is obtained and memory access is possible. In case there is no corresponding address translation couple, a TLBmiss message is generated.

If a TLBmiss message is generated, an interrupt is generated by hardware, and the process moves to hypervisor TLBmiss processing 520. Hypervisor processing with respect to TLBmiss consists of a step 521 of obtaining the physical address of the virtual machine from the virtual address and the RID, a step 522 of obtaining the physical address of the real machine from the physical address of the virtual machine, and a step 523 of registering the virtual address, the RID, and the real machine physical address corresponding thereto as an address translation couple in the TLB. By means of this processing, the TLB is shadowed.

Even in the case where a setRID instruction 501 is executed, an interrupt is generated by hardware and the process moves to hypervisor setRID instruction emulation 510.

Processing of the setRID instruction emulation consists of: a step 511 of granting a virtual machine identifier (vmid) to an RID value (rid) designated with the setRID instruction; a step 512 of modifying the bit positions used in the TLB entry determination of the same value; and a step 513 of setting, in RID register 102, the shadow RID value calculated in the previous two steps.

In the respective steps, Step 511 to Step 513, there are illustrated calculation formulas in the case where the RID value designated with the setRID instruction is taken to be rid, the identifier of the virtual machine is taken to be vmid, the bit positions used in the determination of the TLB entries are taken to be RID[7:0], the translation algorithm is taken to be bit inversion, and the work variable up to the calculation of the shadow RID is taken to be ridwk.

By means of these steps, the RIDs take on unique values in all the processes of all the virtual machines and in addition, the bit positions used in the selection of TLB entries reach the point where those entries are dispersed.

In Step 512, the algorithm of translating the RID bit positions was taken to be bit inversion. As stated previously, this method is particularly valid in the case where the virtual addresses or the RIDs are used in a comparatively small range.

Also, since an arbitrary bit switching manipulation, other than bit inversion, can also become a candidate for the present translation algorithm, it is acceptable to determine the same so that the TLB entries are dispersed in response to the way that the virtual addresses and RIDs are used.

Moreover, regarding the portion that is used for the entry calculation of the TLB entries, if the translation algorithm of Step 512 is one that is a one-to-one translation, it is not limited to bit switching manipulation.

E.g., as shown in FIG. 6, there is also the method of having a 256-entry lookup table 601 and carrying out translation (512-2). In this method, it is possible to accommodate randomly translating the values of RID[7:0].

As mentioned above, according to the present embodiment, in case the TLB is shadowed in a virtualization environment, it is possible to avoid TLB entry conflicts and improve the performance of the virtualization environment.

### 2. Second Embodiment

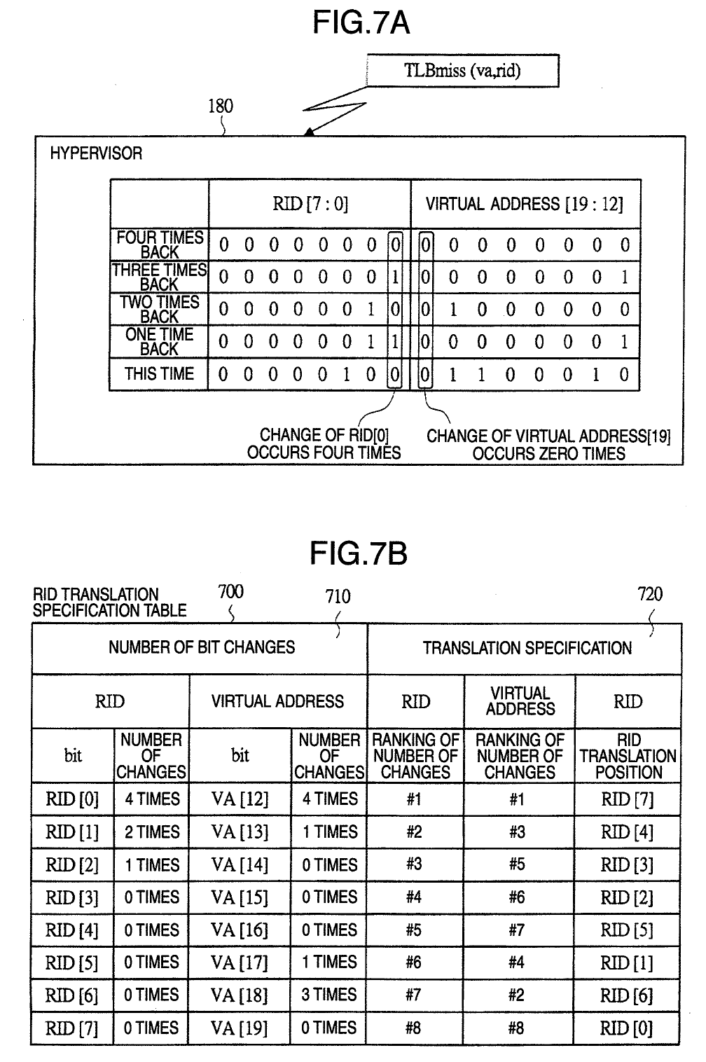

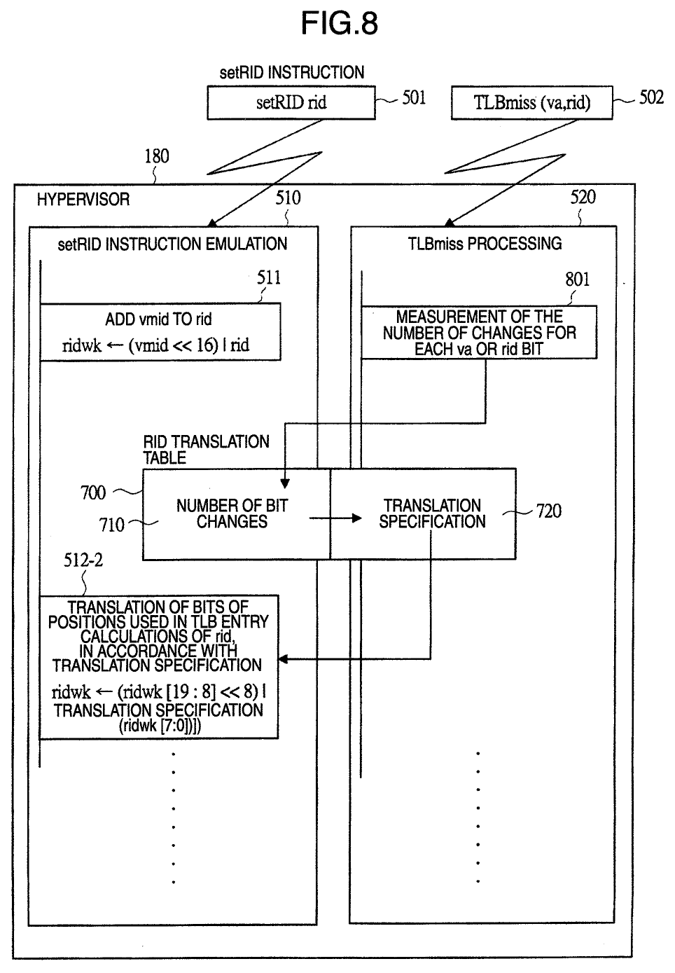

By means of FIGS. 7A and 7B and FIG. 8, there will be given an explanation regarding hypervisor processing occurring in the TLB virtualization of a machine virtualization device related to Embodiment 2 of the present invention. FIGS. 7A and 7B are explanatory diagrams for explaining the principles of hypervisor processing occurring in the TLB virtualization method of a machine virtualization device related to Embodiment 2 of the present invention and FIG. 8 is an explanatory diagram for describing hypervisor processing occurring in the TLB virtualization method of a machine virtualization device related to Embodiment 2 of the present invention, the figures giving indications regarding difference portions with respect to Embodiment 1 shown in FIG. 5.

In FIG. 7A, if a TLBmiss message 502 is generated, there is generated an interrupt with respect to hypervisor 180, involving information about virtual addresses and RIDs that have been impossible to translate. At this point, the number of changes by bit in the virtual addresses and the RIDs are measured.

The number of changes by bit is, in case attention is paid to one bit, the number of times that it changes from the previous time (from “0” to “1” or from “1” to “0”).

Within FIG. 7A, the values of virtual address [19:12] and RID[7:0] were cited as an example, regarding the five TLBmiss messages. In this case, RID[0] changes occurred four times and virtual address [19] changes occurred zero times.

RID translation specification table 700 of FIG. 7B, taking the TLBmiss message of FIG. 7A as an example, is a table administering information about the number of bit changes 710 and a translation specification 720. As for the number of bit changes, there enters a value in which the bit changes of the RID and the virtual address are counted on each occasion of a TLBmiss message.

The translation specification is a table which, after observing the number of changes for a certain fixed interval, attaches a ranking of the number of changes and determines the specification of the RID bit shift so that bits which have a high number of RID changes become bits which have a low number of virtual address changes.

In this example, the value of RID[0] which has a high number of changes is instructed to be shifted to the position of RID[7] so as to correspond to the virtual address [19].

In FIG. 8, if a TLBmiss message 502 is generated, the numbers of changes by bit in the virtual address and the RID are measured (801) and the numbers of bit changes 710 in RID translation table 700 are updated.

After the fixed interval has elapsed, the ranking of the numbers of changes by bit in the virtual address and the RID is obtained and translation specification 720 is determined. At this point, since the translation couples which were already included in the TLB are taken to be invalid, a TLB purge is carried out.

Moreover, in emulation processing 510 of the setRID instruction, a bit shift is carried out (512-2) in accordance with translation specification 720 of RID translation table 700.

As mentioned above, according to the present embodiment, in the case where a TLB is shadowed in a virtualization environment, TLB entry conflicts are avoided and it is possible to improve the performance of the virtualization environment.

Above, the invention made by the present inventors has been explained on the basis of the embodiments, but the present invention is not one limited to the aforementioned embodiments, it going without saying that various modifications are possible without departing from the substance thereof.

1. A TLB virtualization method of a machine virtualization device executing a hypervisor on a real machine, operating an OS on a plurality of virtual machines generated by means of processing based on said hypervisor, and carrying out TLB entry calculations using RID values in said virtual machine by means of said hypervisor processing, comprising: by said hypervisor processing,
translating the RID values, in said virtual machines used in the calculation of TLB entries in said real machine to different values in said plurality of virtual machines; and
modifying the values of the bit strings of said translated RID values.

2. The TLB virtualization method of a machine virtualization device according to claim 1, wherein the modification of the values of the bit strings of said RID values based on said hypervisor processing is carried out by inverting the bit strings of said RID values.

3. The TLB virtualization method of a machine virtualization device according to claim 1, wherein the modification of the values of the bit strings of said RID values based on said hypervisor processing is carried out by consulting a lookup table for making a one-to-one translation of the bit strings of said RID values.

4. The TLB virtualization method of a machine virtualization device according to claim 1, wherein the modification of the values of the bit strings of said RID values based on said hypervisor processing is carried out by exchanging the values of an arbitrary set of bits inside the bit strings of said RID values.

5. The TLB virtualization method of a machine virtualization device according to claim 4, wherein:
the modification of the values of the bit strings of said RID values based on said hypervisor processing is carried out:
by measuring the number of changes of bits of said RID values and a virtual address by means of said hypervisor processing; and so that
those bits having a high number of changes among the bits of said RID values used in said TLB entry calculations are multiplied with those bits having a low number of changes among the bits of said virtual address used in said TLB entry calculations; and
those bits having a low number of changes among the bits of said RID values used in said TLB entry calculations are multiplied with those bits having a high number of changes among the bits of said virtual address used in said TLB entry calculations.

6. A machine virtualization program executed on a real machine and which generates a plurality of virtual machines in said real machine, operates an OS on said plurality of virtual machines, and carries out TLB entry calculations using the RID values in said virtual machines, comprising:
translating the RID values in said virtual machines used in the TLB entry calculations in said real machine into different values in said plurality of virtual machines; and
modifying the values of the bit strings of said translated RID values.

7. The machine virtualization program according to claim 6, wherein the modification of the values of the bit strings of said RID values is carried out by inverting the bit strings of said RID values.

8. The machine virtualization program according to claim 6, wherein the modification of the values of the bit strings of said RID values is carried out by consulting a lookup table for making a one-to-one translation of the bit strings of said RID values.

9. The machine virtualization program according to claim 6, wherein the modification of the values of the bit strings of said RID values is carried out by exchanging the values of a set of arbitrary bits inside the bit strings of said RID values.

10. The machine virtualization program according to claim 9, wherein the modification of the values of the bit strings of said RID values is carried out:
by measuring the number of changes of bits of said RID values and a virtual address by means of said hypervisor processing; and so that
those bits having a high number of changes among the bits of said RID values used in said TLB entry calculations are multiplied with those bits having a low number of changes among the bits of said virtual address used in said TLB entry calculations; and
those bits having a low number of changes among the bits of said RID values used in said TLB entry calculations are multiplied with those bits having a high number of changes among the bits of said virtual address used in said TLB entry calculations.
